(19) United States
(12) Patent Application Publication
(10) Pub. No.: US 2018/0202399 A1
(43) Pub. Date: Jul. 19, 2018

(54) MULTIPLE ORIFICE ASPIRATOR HAVING CUSTOMER-ADJUSTABLE FLOW VOLUME FOR USE WITH A VACUUM SYSTEM

(71) Applicant: Ford Global Technologies, LLC, Dearborn, MI (US)

(72) Inventors: Snehasis Ganguly, Canton, MI (US); Hari B. Jarugula, Northville, MI (US)

(21) Appl. No.: 15/408,811

(22) Filed: Jan. 18, 2017

(51) Int. Cl. F02M 35/10; F02B 67/08; F02D 9/02; B60T 13/57

(52) U.S. Cl. CPC F02M 35/10229; F02B 67/08; F02D 2009/024; B60T 13/57; F02D 9/02

(57) ABSTRACT

A manually adjustable aspirator is disclosed for use in a vacuum system for a vehicle having a vacuum source. The aspirator includes a passageway having a diameter that can be adjusted by a vehicle operator for different altitudes. The aspirator includes a body, a passageway having a narrowed aperture defined by opposed cones, and a manually adjustable flow adjuster having an adjustment knob. A brake booster is connected to the aspirator. An air intake is connected with a vacuum source and the aspirator. The cones include first and second cones each having a narrowed end. The narrowed ends are joined at a narrow aperture that defines an inner diameter. The flow rate adjuster regulates the size of the inner diameter. Adjustment of the knob allows operator selection between a high boost in a high altitude location and a low boost in a low altitude location having a higher source vacuum.

### TECHNICAL FIELD

The disclosed inventive concept relates generally to vacuum systems for use with automotive vehicles. More particularly, the disclosed inventive concept relates to an aspirator having multiple orifices for use in a vacuum system for a vehicle. The flow rate of gas through the aspirator may be adjusted by the vehicle operator when the vehicle is selectively moved between locations having different altitudes.

### BACKGROUND OF THE INVENTION

The modern automotive vehicle typically includes various vacuum-dependent components that rely on a vacuum system for actuation. The vehicle's brake booster is perhaps the most important of these components. The vacuum needed for such systems may be generated by a pump dedicated to this purpose. Such a pump may be driven by an electric motor or may be driven by the engine itself. However, such active systems reduce operating efficiency of the vehicle by drawing vehicle power either indirectly as in the case of the electric motor or directly as in the case of the engine-driven pump.

Accordingly, instead of relying on an energy-taxing pump, vacuum arrangements involving the use of at least one aspirator are used in conjunction with intake airflow to create the necessary vacuum. The aspirator, sometimes referred to as a venturi, is a passive flow mechanism that is able to provide the necessary system vacuum when the internal combustion engine is operating. Because the aspirator utilizes existing systems that themselves create a vacuum under normal operating conditions, no modification of the engine is required.

The vacuum generated by the aspirator can be controlled as desired to meet the specific operating requirements of associated components such as the brake booster. The brake booster is fitted to most newer vehicles and operates to apply supplemental braking force in the brake system. The conventional brake booster is typically connected to the master cylinder and is mounted on the engine side of the firewall.

The use of the known aspirator in vehicle vacuum systems, while providing a relatively reliable approach to generating the appropriate vacuum for use by vacuum-consuming components, does have its limitations. One such limitation arises when the vehicle is moved from one altitude to another. Under such circumstance, the ambient air pressure is different between low and high altitudes while the parameters of operation of the aspirator remain fixed.

Because the passageway of the conventional aspirator is of a fixed diameter, the vacuum system cannot be adjusted to compensate for such changes in ambient air pressure at different altitudes. This fixed diameter results in compromised vacuum system performance when the vehicle is moved between locations at different altitudes.

Accordingly, as in so many areas of vehicle technology there is always room for improvements related to vacuum systems and associated components. Particularly, it would be advantageous to provide an improved aspirator that can operate efficiently and effectively and different altitudes based on operator-initiated adjustments.

### SUMMARY OF THE INVENTION

The disclosed inventive concept provides a manually adjustable aspirator for use in a vacuum system for a vehicle having a vacuum source, such as the intake manifold of an internal combustion engine. The aspirator includes a passageway having a diameter that can be adjusted by a vehicle operator. A manually adjustable flow adjuster is provided to regulate the vacuum. Selective positioning of the flow adjuster allows operator selection between a relatively high boost in a relatively high altitude location having a relatively low source vacuum and a relatively low boost in a relatively low altitude location having a higher source vacuum.

Particularly, the operator-adjustable variable flow aspirator of the disclosed inventive concept includes a body, a first passageway having a narrowed aperture defined by opposed cones, a second passageway, and a manually adjustable flow adjuster operatively associated with the aperture. A brake booster is connected to the aspirator by a vacuum line. An air intake connected with a vacuum source and the aspirator by vacuum lines. The opposed cones include a first cone having a narrowed end and a second cone having a narrowed end. The narrowed ends are joined at a narrow aperture that defines an inner diameter.

The manually adjustable flow adjuster includes a rotatably adjustable, finger-manipulable control knob and a threaded stem extending from the control knob. The stem is an aperture blocking portion that is reversibly movable between positions of increased and decreased aperture blocking of the narrowed inner diameter of the first passageway.

The manually adjustable aspirator is the part of vacuum boost system of a vehicle used to enhance braking, fuel and other systems by boosting vacuum pressure within the system. In high altitude situations, source vacuum is low. The aspirator can be used to provide different gains. The knob is used to manually control the size of the opening of the aspirator. A user can turn the knob to change the boost. The knob is used to change boost according to the altitude on which the vehicle is used since pressure decreases as altitude increases. For example, as the knob is turned in, the cross section of the passageway of the aspirator is reduced, thereby producing a gain and boost change.

Accordingly, the flow rate of the aspirator may be adjusted by the customer when the vehicle is moved between locations having different altitudes. For example, at a lower source vacuum in high altitude situation such as Denver, Colo., the dealer or the customer can turn the knob to achieve 0.08 inch diameter of orifice. If the customer moves to a different altitude, the knob can be changed over to 0.06 inch diameter of orifice. The source vacuum changes with the altitude. This is a highly desirable feature for the operator driving, for example, from the plains to the mountains.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a side view of the multiple orifice aspirator according to the disclosed inventive concept;

FIG. 2 is a top view of the multiple orifice aspirator according to the disclosed inventive concept;

FIG. 3 is a sectional view of the multiple orifice aspirator according to the disclosed inventive concept; and

FIG. 4 is a diagrammatic representation of the multiple orifice aspirator in a vehicle system.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The disclosed inventive concept is illustrated in the accompanying figures in which a suggested embodiment of the manually adjustable aspirator for use in a vacuum system for a vehicle having a vacuum source is shown. The aspirator and its accompanying system as described and illustrated in the accompanying figures are suggestive and are not intended as being limiting. For example, while the manually adjustable flow adjuster arrangement is illustrated herein as being associated with an aspirator having two airflow passageways, it is conceivable that the flow adjuster may also have application with an alternative system such as one having a single airflow passageway or one having more than two passageways. Accordingly, the system of the disclosed inventive concept may be adapted for use in any circumstance where regulation of the vacuum is desired by operator manipulation.

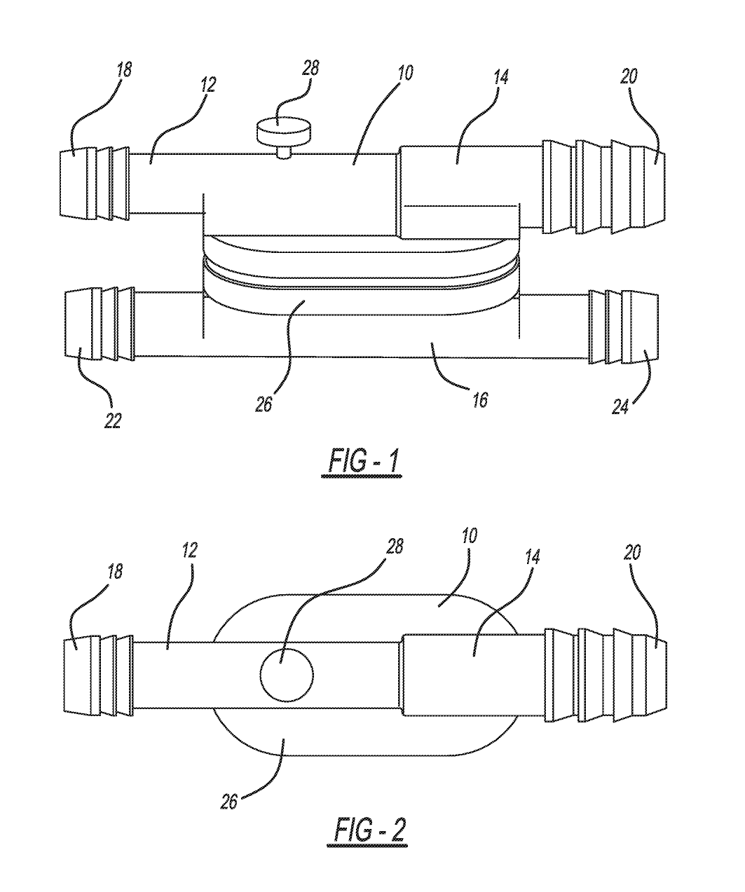

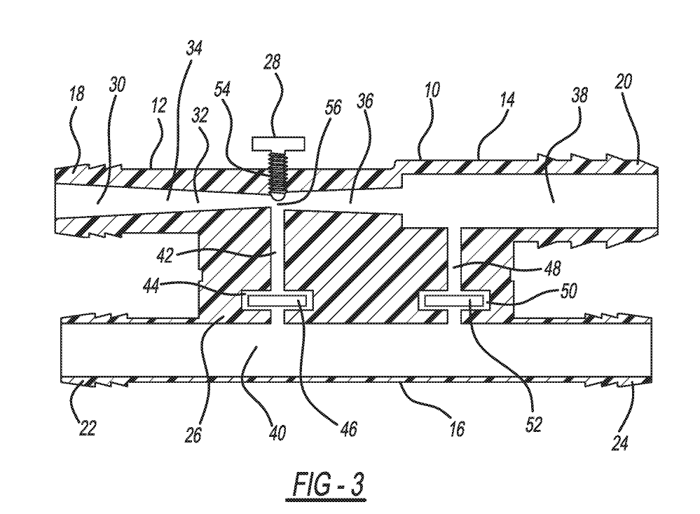

Referring to FIGS. 1 through 3, a manually adjustable aspirator 10 is illustrated in various views. The manually adjustable aspirator 10 may have use in any of several vacuum arrangements in an automotive vehicle including, without limitation, brakes, air conditioners and automatic transmissions. The manually adjustable aspirator 10 includes an aspirator body 12 that may be a single-piece molded component or may be a multi-piece component. For example, and referring to FIGS. 1 and 3, the aspirator body 12 includes a first half 14 and a second half 16. The aspirator body 12 may be formed from any of several materials including, without limitation, any of several plastics or a metal.

Referring again to FIGS. 1 through 3, the first half 14 of the aspirator body 12 includes two opposed sides defining two ports, the ports including a venturi air intake port 18 and a vacuum source port 20. The second half 16 includes two sides defining two ports, the ports including a brake booster port 22 and an auxiliary port 24 that may capped or connected to another vacuum-reliant component. Formed generally between the first half 14 and the second half 16 is a diaphragm housing 26. A manually adjustable flow adjuster 28 is adjustably provided in association with the first half 14 of the aspirator body 12. The manually adjustable flow adjuster 28 includes an operator manipulable control knob that may include a direction arrow formed on its face.

FIG. 3 illustrates a sectional view of the manually adjustable aspirator 10. As previously noted, the flow control arrangement of the disclosed inventive concept may be adapted for use in any of several vacuum flow regulating systems. Accordingly, the arrangement illustrated in FIG. 3 and discussed in conjunction therewith is only suggestive and is not intended as being limiting.

The manually adjustable aspirator 10 as illustrated in FIG. 3 includes a first passageway 30 formed in the first half 14 of the aspirator body 12 between the venturi air intake port 18 and the vacuum source port 20. The first passageway 30 includes a venturi portion 32 defined by a first conical venturi passageway 34 and a second conical venturi passageway 36. The first conical venturi passageway 34 includes a wide end associated with the venturi air intake port 18. The second conical venturi passageway 36 includes a wide end that is continuous with an extended passageway 38 that is associated with the vacuum source port 20. Unlike the conical shapes of the first conical venturi passageway 34 and the second conical venturi passageway 36, the extended passageway 38 has an interior diameter that is constant.

The manually adjustable aspirator 10 as illustrated in FIG. 3 further includes a second passageway 40 formed in the second half 16 of the aspirator body 12 between the brake booster port 22 and the auxiliary port 24. The second passageway has an interior diameter that is constant.

Regulated transverse passageways are provided between the first passageway 30 and the second passageway 40 to regulate the vacuum between the two passageways 30 and 40. The regulated transverse passageways include a first transverse passageway 42 that includes a first diaphragm housing 44 having therein a movably adjustable first diaphragm 46. The regulated transverse passageways further include a second transverse passageway 48 that includes a second diaphragm housing 50 having therein a movably adjustable second diaphragm 52. The first movably adjustable diaphragm 46 and the second movably adjustable diaphragm 52 operate to regulate vacuum between the first passageway 30 and the second passageway 40 by selectively opening or closing the first transverse passageway 42 and the second transverse passageway 48.

The manually adjustable flow adjuster 28 includes a threaded portion 54 in the form of a stem that extends from the adjuster knob. The threaded portion 54 is a passageway blocking portion that is movable within a passageway 56 formed by the narrowest ends of the first conical venturi passageway 34 and the second conical venturi passageway 36. Operator controlled movement of the manually adjustable flow adjuster 28 results in changes in the size of the passageway 56 to thereby regulate the vacuum of the manually adjustable aspirator 10.

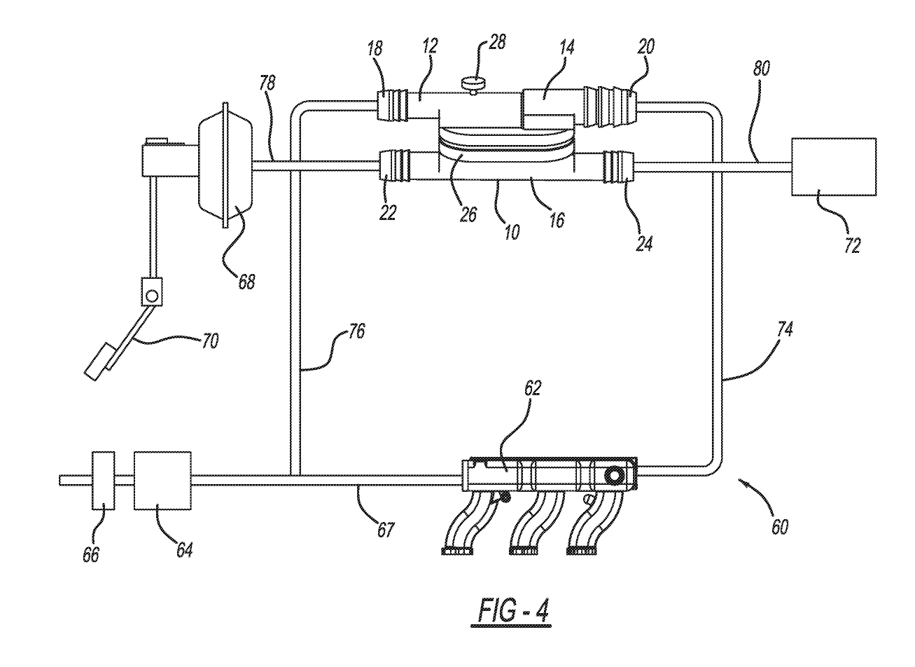

The manually adjustable aspirator 10, as previously noted, has several applications for use in an automotive vacuum system. One such vacuum system is diagrammatically illustrated in FIG. 4 in which a vacuum system 60 is illustrated. The vacuum system 60 as shown is only suggestive as other arrangements may be possible without deviating from the spirit or scope of the disclosed inventive concept.

With reference to FIG. 4, the vacuum system 60 includes a vacuum source such as an intake manifold 62. One end of the intake manifold is attached to an air inlet 64 or snorkel that is conventionally provided with an air filter 66. An air intake pipe 67 connects the air inlet 64 to the intake manifold 62.

The system 60 further conventionally includes a brake booster 68 to which is attached a brake pedal assembly 70. The system 60 includes an auxiliary vacuum boosted component 72 which may be any of an air conditioner, a CCD, cruise control, or any one of several auxiliary components that require a vacuum source for operation. A first vacuum line 74 connects the manually adjustable aspirator 10 to the intake manifold 62 and a second vacuum line 76 connects the manually adjustable aspirator 10 to the air intake pipe 67. A third vacuum line 78 connects the manually adjustable aspirator 10 to the brake booster 68 and a fourth vacuum line 80 connects the manually adjustable aspirator 10 to the auxiliary vacuum-boosted component 72 (if present).

In operation, the vehicle operator may readily open the vehicle's engine hood and adjust the manually adjustable flow adjuster 28 as required if the vehicle is moved from one elevation to another, thereby achieving different gains by selectively controlling the size of the passageway 56. This adjustment is made to adjust for pressure differences at different altitudes. For example, if the operator chooses to move the vehicle to a higher elevation, the manually adjustable flow adjuster 28 is rotated in a direction toward the manually adjustable aspirator 10 resulting in the reduction of the cross section of the passageway 56, thereby producing a vacuum gain and boost change.

One skilled in the art will readily recognize from such discussion, and from the accompanying drawings and claims that various changes, modifications and variations can be made therein without departing from the true spirit and fair scope of the invention as defined by the following claims.

1. A vacuum system for a vehicle having a vacuum source, the system comprising:
a variable flow aspirator comprising a body, a first passageway having a narrowed aperture defined by opposed cones, a second passageway, and a manually adjustable flow adjuster operatively associated with said aperture;
a brake booster connected to said aspirator by a vacuum line; and
an air intake connected with the vacuum source and said aspirator by vacuum lines.

2. The vacuum system for a vehicle of claim 1 wherein said opposed cones include a first cone having a narrowed end and a second cone having a narrowed end, said narrowed ends being joined at a narrow aperture, said aperture having an inner diameter.

3. The vacuum system for a vehicle of claim 1 wherein said manually adjustable flow adjuster includes a finger-manipulable control knob.

4. The vacuum system for a vehicle of claim 1 wherein said manually adjustable flow adjuster includes an aperture blocking portion reversibly movable between positions of increased and decreased aperture blocking.

5. The vacuum system for a vehicle of claim 1 wherein said flow adjuster is rotatably adjustable.

6. The vacuum system for a vehicle of claim 1 wherein said aperture blocking portion is a stem extending from said knob.

7. (canceled)

6. (canceled)

7. The variable flow aspirator of claim 1 wherein said body has first and second ends, said ends being opposed and wherein said first passageway and said second passageway are parallel.

8. The variable flow aspirator of claim 7 wherein said first and second passageways extend between said first and second ends.

9. The variable flow aspirator of claim 1 wherein said second passageway has a diameter, said diameter being constant between said first and second ends.

10. A variable flow aspirator comprising:
a body;
a first passageway having a first cone with a narrowed end an a second cone with a narrowed end, said narrowed ends being joined at a narrow aperture, said aperture having an inner diameter;
a second passageway;
a flow adjuster operatively associated with said inner diameter, said adjuster having a knob, said adjuster including an aperture blocking portion reversibly movable between positions of increased and decreased aperture blocking.

11. The variable flow aspirator of claim 10 wherein said knob is finger-manipulable.

12. The variable flow aspirator of claim 10 wherein said flow adjuster is rotatably adjustable.

13. The variable flow aspirator of claim 10 wherein said aperture blocking portion is a stem extending from said knob.

14. The variable flow aspirator of claim 13 wherein said stem is threaded.

15. The variable flow aspirator of claim 10 wherein said first passageway and said second passageway are parallel.

16. The variable flow aspirator of claim 10 wherein said body has first and second ends, said ends being opposed.

17. The variable flow aspirator of claim 16 wherein said first and second passageways extend between said first and second ends.

18. The variable flow aspirator of claim 10 wherein said second passageway has a diameter, said diameter being constant between said first and second ends.

19. A method of manually adjusting the vacuum boost in a motorized vehicle, the method comprising:
forming a vacuum system including a variable flow aspirator comprising a body, a first passageway having a narrowed aperture defined by opposed cones, a second passageway, and a manually adjustable flow adjuster operatively associated with said aperture, a brake booster connected to said aspirator by a vacuum line, and an air intake connected with the vacuum source and said aspirator by vacuum lines; and
selectively adjusting said aspirator between a relatively high boost in a relatively high altitude location having a relatively low source vacuum and a relatively low boost in a relatively low altitude location having a higher source vacuum.

20. The method of manually adjusting the vacuum boost of claim 19 wherein said manually adjustable flow adjuster includes an aperture blocking portion reversibly movable between positions of increased and decreased aperture blocking.
